(19) United States
(12) Patent Application Publication
(10) Pub. No.: US 2013/0042972 A1
(43) Pub. Date: Feb. 21, 2013

(54) Dual Cure Thermally Conductive Adhesive

(71) Applicants: John Timmerman, Minneapolis, MN (US); Sanjay Misra, Shoreview, MN (US)

(72) Inventors: John Timmerman, Minneapolis, MN (US); Sanjay Misra, Shoreview, MN (US)

(21) Appl. No.: 13/210,545

(22) Filed: Aug. 16, 2011

(51) Int. Cl. B32B 37/12; C09J 181/00; C09J 183/16; C09J 9/00; C09J 175/14

(52) U.S. Cl. 156/275.5; 252/78.1; 522/90; 522/172

(57) ABSTRACT

A thermally conductive adhesive for use in connection with heat-generating electronic components includes an unsaturated carbonyl containing compound combined with a thiol containing compound blended with thermally conductive fillers. The adhesive is fully curable with UV light exposure or within 48 hours at room temperature. The combination of the two different cure methods in this adhesive facilitates rapid and energy efficient manufacturing.

### FIELD OF THE INVENTION

The present invention relates to curable thermally conductive interface structures generally, and more particularly to a curable thermally conductive interface incorporating a material that can react fully with exposure to UV light or with time at room temperature.

### BACKGROUND OF THE INVENTION

Modern electronic devices involve a wide variety of operating electronic components mounted in close proximity with one another. Demand for increased performance and decreased size for such electronic components, has resulted in elevated levels of heat generation. For many electronic components operating efficiency is decreased at elevated temperatures, such that mechanisms are desired for heat transfer away from the electronic components. Accordingly, it is known in the art to utilize heat transfer aids such as cooling fans for moving air across the devices, cooling fluid conductor pipes, and large surface area heat sinks for removing thermal energy from in and around the respective electronic components.

A common technique for removing excess thermal energy from the heat-generating electronic components involves thermally coupling the electronic component to a relatively large surface area heat sink, which is typically made of a highly thermally conductive material, such as metal. Heat transfer away from the heat sink typically occurs at the interface between the heat sink and a cooling media such as air. In some cases, heat transfer efficiency is increased through the use of fans to direct a continuous flow of air over the heat exchanging surfaces of the heat sink.

In some instances, an interfacial material, such as a thermally conductive paste or gel, may be interposed between the heat-generating electronic component and the heat sink in order to increase heat transfer efficiency from the electronic component to the heat sink. Interfacial voids caused by uneven surfaces at the interface between the electronic component structure and the heat sink introduce thermal barriers which inhibit passage of thermal energy thereacross. The interfacial material seeks to minimize such voids to eliminate thermal barriers and increase heat transfer efficiency.

Thermally conductive pastes or gels commonly exhibit relatively low bulk modulus, and may even be “phase changing” in that the interfacial material becomes partially liquidous and flowable at the elevated temperatures consistent with the operation of the heat-generating electronic component. Although the use of such interfacial materials has proven to be adequate for many applications, certain drawbacks nevertheless exist. For example, some of such interfacial materials require additional structures to secure the heat-generating component to the heat-dissipating component to ensure that the components maintain good thermal contact. These additional structures take up space and weight that could otherwise be avoided. For this reason, thermally conductive curable liquid adhesives can be used to transfer heat between the two components without the need for fastening structures. The liquid adhesive may be applied as a liquid and then cured in place to secure the components with good thermal contact. Conventional liquid adhesives typically cure through a single mechanism such as heat, UV exposure, moisture exposure, and so forth.

Single-mechanism cure adhesives can limit the speed and efficiency with which thermal packages may be assembled. For example, typical ambient temperature curable liquid adhesives require a relatively long cure time, such as at least about 120 minutes, to fully cure. The required ambient temperature exposure time significantly adds to the overall assembly process time, as the adhesive cure portion of the process can represent a limiting factor in package assembly time since the package is typically not handled during cure. Other cure modalities also have drawbacks, which represent a hindrance to through-put of the package assembling process. Thermal transfer packages may typically employ adhesives which are curable at elevated temperatures, thereby necessitating heating equipment such as ovens to cure the adhesive within acceptable time limitations. Such heating and heating equipment add significantly to the process time, cost, and complexity. Moreover, a “full cure” of conventional single cure mechanism materials is required to be performed by the curing agent in the manufacturing process in order to ensure that the finished product is securely constructed as a finished product ready for shipment and use.

Package assembly processes could be greatly improved if a full cure of the liquid adhesive was not required on the assembly line. Therefore, a need has arisen to obtain a liquid adhesive that is at least partially curable upon a short exposure time to a curing agent so that the assembled package can be removed from the assembly line and safely handled prior to a full cure of the liquid adhesive. Moreover, it is desired that the second-stage curing process be performed without the need for expensive curing equipment and materials, and may also be performed without the need for fastening structures to hold the respective package components in place during the final cure. In this manner, assembled packages could be removed from the assembly line after a short initial cure period, and placed in a “second-stage” curing location for final and full cure of the liquid adhesive. Removal of the assembled packages from the assembly line after only a short initial curing stage significantly increases production speed of the electronic packages.

Accordingly, it is a primary object of the present invention to provide a thermally conductive adhesive that is thermally conductive and curable through at least two different mechanisms.

It is a further object of the present invention to provide a thermally conductive adhesive that cures completely at room temperature or with exposure to UV light.

### SUMMARY OF THE INVENTION

By means of the present invention, an electronic package may be rapidly assembled without requiring accessory fastening structures. The electronic package assembly utilizes a thermally conductive adhesive which cures through exposure to one or both of UV radiation and room temperature. In one embodiment, the adhesive fully cures in 48 hours or less at room temperature (25° C.) and within 1 minute with exposure to UV light. Once fully cured, the adhesive exhibits a bond strength of 75-750 psi depending on the particular structure of the components used and a modulus at 25° C. of 7200 to 140000 psi. The thermal conductivity of the interface adhesive is greater than 0.5 W/m*K

### BRIEF DESCRIPTION OF THE DRAWINGS

FIG. 1 is a schematic illustration of an electronic component assembly of the present invention.

### DETAILED DESCRIPTION OF THE PREFERRED EMBODIMENTS

The objects and advantages enumerated above together with other objects, features, and advances represented by the present invention will now be presented in terms of detailed embodiments. Other embodiments and aspects of the invention are recognized as being within the grasp of those having ordinary skill in the art.

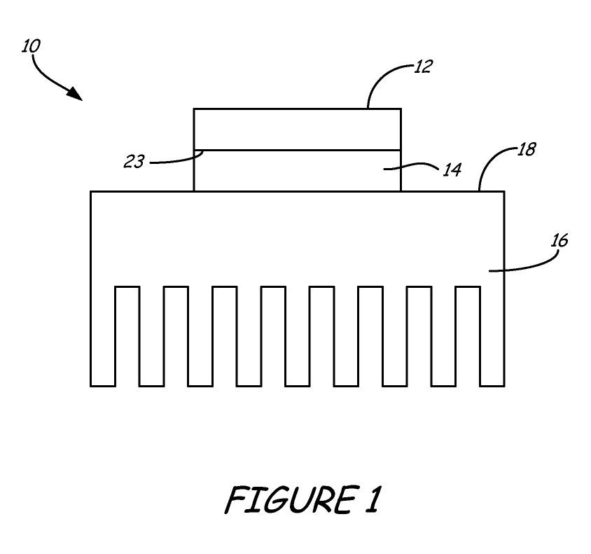

With reference now to FIG. 1, an electronic component assembly 10 includes a heat-generating electronic component 12, and a thermally conductive adhesive 14 which is thermally coupled to electronic component 12. In the embodiment illustrated in FIG. 1, a heat sink 16 is also included in the electronic component assembly, and is in thermal contact with thermally conductive adhesive 14 at a first surface 18 of heat sink 16. In general, the generic arrangement illustrated in FIG. 1, wherein a thermally conductive material or object is interposed between a heat-generating electronic component and a heat sink, is known in the art. However, Applicants have determined that a unique thermally conductive adhesive 14 provides distinct advantages over conventional thermally conductive interface adhesives in that it fully cures either through UV radiation exposure or time at room temperature.

For the purposes hereof, the term “fully curable”, “fully cure”, “fully cures”, or “fully cured” is intended to mean a material which has undergone a polymerization reaction in which a majority of the polymerizing groups have reacted. In other words, a full cure has been achieved when a majority of the active groups in the reactants targeted for polymerization have indeed polymerized. In addition, the term “UV exposure”, “UV radiation exposure”, “UV light”, or similar terms, is intended to mean a dosage of 200-500 nanometer wavelength radiation delivered to the reactants in a manner suitable to polymerize the polymerizable target groups in the reactants. The term “room temperature” is intended to mean about 25° C.

Heat-generating electronic component 12 is schematically illustrated in FIG. 1 as a generic device. Such component 12, however, may in practice represent a wide variety of electronic devices, such as microprocessors, integrated circuits, memory chips, hard drives, light emitting diodes, and the like. In the embodiment illustrated in FIG. 1, a first surface 23 of interface structure 14 is thermally coupled with electronic component 12, and preferably with a heat-emitting surface of electronic component 12. It is to be understood that the term “electronic component” is meant to be inclusive of all parts associated with a respective electronic device, in that the adhesive 14 may be placed in thermal contact with one or more elements associated with an assembly making up electronic component 12.

In the arrangement illustrated in FIG. 1, the adhesive 14 is interposed between electronic component 12 and heat sink 16. In the construction of electronic component assembly 10, the adhesive 14 is sandwiched between electronic component 12 and heat sink 16, and will experience thermal and mechanical stresses during operation. As discussed above, in order to maintain good thermal contact between the electronic component 12 and the heat sink 16, the cured adhesive 14 may withstand such stresses without macro or microscopic failure. On the other hand, in order to be readily delivered to the interface between electronic component 12 and heat sink 16, the adhesive is preferably in a liquid state, with a viscosity below 2,000,000cP at 25° C. as measured at 2 rpm using a Brookfield viscometer. However, a liquid state material alone is not typically able to reliably secure the electronic component 12 to the heat sink 16. Therefore, the adhesive is curable from a liquid state to solid state over time or with exposure to the appropriate external environment. The solid state cured adhesive may exhibit an elastic modulus of about 20,000 psi, as measured through dynamic mechanical analysis through ASTM D1002. It is contemplated that fully cured adhesives of the present invention may exhibit somewhat greater or lesser elastic modulus values than 20,000 psi, so long as the fully cured adhesives are structurally sound, and are capable of securing together respective component parts without micro or macroscopic failure under typical lifespan operating conditions.

In many cases, it is desirable for the curing reaction to occur at low temperatures, for example between 15 and 25° C., so that significant energy does not have to be expended in the manufacturing process for heating. However, it is also desirable for the cure process to complete quickly so that the manufacturing process can proceed rapidly. Consequently, the present adhesive is proposed, wherein the adhesive is curable through multiple methods, facilitating rapid manufacturing and low energy uses. Specifically, the present adhesive cures quickly through either UV radiation exposure or curing in 48 hours or less at 25° C., even in the absence of UV radiation. In one embodiment, the adhesive is curable through the unique combination of a thiol-containing species and an unsaturated carbonyl-containing species in a two-part system.

It has been determined that a two-part reaction system of a thiol-containing material and an unsaturated carbonyl-containing material may present a polymerizable reaction system in which a single polymerization reaction sequence may be initiated by either UV radiation exposure or simply by time of the two-part reactant system at room temperature. In particular, the reactant system of the present invention does not involve multiple distinct polymerization reactions, but instead involves a single reaction sequence that may be driven by any one of a plurality of reaction initiators. In one embodiment, the reaction initiators include UV radiation and time at 25° C. In one aspect of the presently proposed system, the polymerization reaction may be completed even in the absence of atmospheric oxygen. The single reaction sequence in one embodiment is the reaction of the thiol with an unsaturated carbonyl group, initiated by either UV radiation exposure or room temperature exposure for up to forty-eight hours. It has been determined that at least 70% of the thiol and alpha, beta unsaturated carbonyl groups of the reactant system polymerize when exposed to either one of UV radiation exposure (200-500 nanometers) for one minute, or, in the absence of other initiators, within forty-eight hours at 25° C.

Example unsaturated carbonyl materials useful in the present reactions include highly propoxylated (5.5) gylceryl triacrylate, difunctional polyurethane acrylate, ethylene glycol diacrylate, propylene glycol diacrylate, polyethylene glycol diacrylate, polypropylene glycol diacrylate, propylene glycol glycerolate diacrylate, polypropylene glycol glycerolate diacrylate, trimethylolpropanetriactylate, pentaerythritol tetraacrylate, polyethylene glycol dimethacrylate, polypropylene glycol dimethacrylate, ethylene glycol dimethacrylate, propylene glycol dimethacrylate, 1,12 dodecanediol dimethacrylate, 1,3-butylene glycol diacrylate, 1,3-butylene glycol dimethacrylate, 1,4-butanediol diacrylate, 1,4-butanediol dimethacrylate, 1,6 hexanediol diacrylate, 1,6 hexanediol dimethacrylate, alkoxylated aliphatic diacrylate, alkoxylated hexanediol diacrylate, alkoxylated neopentyl glycol diacrylate, cyclohexane dimethanol diacrylate, cyclohexane dimethanol dimethacrylate, ethoxylated (10) bisphenol a diacrylate, ethoxylated (2) bisphenol a dimethacrylate, ethoxylated (3) bisphenol a diacrylate, ethoxylated (30) bisphenol a diacrylate, ethoxylated (30) bisphenol a dimethacrylate, ethoxylated (4) bisphenol a diacrylate, ethoxylated (4) bisphenol a dimethacrylate, ethoxylated (8) bisphenol a dimethacrylate, ethoxylated (10) bisphenol dimethacrylate, ethoxylated (6) bisphenol a dimethacrylate, ethylene glycol dimethacrylate, neopentyl glycol diacrylate, neopentyl glycol dimethacrylate, polyester diacrylate, difunctional aliphatic silicone acrylate, di-trimethylolpropane tetraacrylate, dipentaerythritol pentaacrylate, ethoxylated (4) pentaerythritol tetraacrylate, pentaacrylate ester, pentaerythritol tetraacrylate, ethoxylated (15) trimethylolpropane triacrylate, ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate, pentaerythritol triacrylate, propoxylated (3) glyceryl triacrylate, propoxylated (3) trimethylolpropane triacrylate, propoxylated (6) trimethylolpropane triacrylate, trimethylolpropane trimethacrylate, and tris (2-hydroxy ethyl) isocyanurate triacrylate.

Example thiol materials useful in the present reactions include the following: trimethylolpropane tris (3-mercaptopropionate), tris[2-(3-mercaptopropionyloxy)ethyl]isocyanurate, pentaerythritol tetrakis(3-mercaptopropionate), and ethoxylated pentaerythritol tetrakis (3-mercaptopropionate).

In some embodiments, a UV initiator may be employed to assist and/or accelerate polymerization driven by exposure to UV radiation. The following example UV initiators may be useful in the present reactions: 2,2-diethoxyacetophenone, benzophenone, dimethoxyphenylacetophenone, hydroxydimethylacetophenone, 2-hydroxy-4′-(2-hydroxyethoxy)-2-methylpropiophenone, 1-hydroxycyclohexyl phenyl ketone, 2-benzyl-2-(dimethylamino)-4′-morpholinobutyrophenone, 2-hydroxy-2-methylpropiophenone, 3′-hydroxyacetophenone, 2-methylbenzophenone, 3-methylbenzophenone, 3,4-dimethylbenzophenone, 4,4′-dihydroxybenzophenone, 4-hydroxybenzophenone, 2-hydroxy-1,2-di(phenyl)ethanone, and 1,2-diphenylethane-1,2-dione.

In some embodiments, a basic polymerization accelerator may be employed to assist and/or accelerate the present polymerization reaction. The following example reaction accelerators may be useful in the present reactions: triphenyl phosphine, diphenyl phosphine, dimethylphenyl phosphine, methyldiphenyl phosphine, tri-p-tolyl phosphine, tri-o-tolyl phosphine, tri-m-tolyl phosphine, diphenyl-p-tolyl phosphine, di-m-tolyl phenyl phosphine, and tris(2,4,6-trimethylphenyl)phosphine.

The combination of two difunctional monomers/oligomers produces a thermoplastic product, whereas the use of one or more monomers/oligomers with a functionality of greater than two yields a cross-linked material.

It is also contemplated that some combination of UV exposure and room temperature time exposure may be utilized in the curing of the present adhesive. In the event, therefore, that UV radiation is applied to the curable liquid adhesive reactant system for some period of time, the required room-temperature based cure may accomplish a full cure of the adhesive within less than 48 hours. It is to be understood that reaction conditions can affect cure times for the curable adhesive of the present invention, so that specific time requirements to achieve a full cure may be dependant upon the specific characteristics of any given reaction. Nevertheless, the proposed adhesive system is fully curable through the application of the above-described polymerization vehicles, either alone or in combination with one another.

In addition to being fully curable through multiple distinct pathways, the present adhesive may also exhibit a thermal conductivity in excess of 0.5 W/m·K. The thermal conductivity of the adhesive may be enhanced through filling of the monomer/oligomer/polymer mixture with thermally conductive particulate or fibrous fillers. Such fillers may be ceramic materials such as alumina, aluminum nitride, aluminum hydroxide, boron nitride, silica, and the like, as well as other inorganic materials and metals. Most typically, the particulate fillers are present at a loading concentration of between about 50 and 90% by weight, and have a particulate size distribution with a mean particle size of about 30-50 microns. Thermally conductive filled polymer materials are well understood in the art as an interfacial media in heat transfer applications, however a thermally conductive liquid adhesive with the ability to cure at room temperature or with UV exposure has not been seen.

### EXAMPLES

The following sets forth example adhesive compositions of the present invention. The following examples, however, are intended to be exemplary only, and not restrictive as to the arrangements and materials useful in the present invention.

### Example 1

A thermally conductive adhesive was prepared by mixing a difunctional alpha, beta unsaturated carbonyl containing compound with a trifunctional polyether thiol in the presence of a basic accelerator and a photoinitiator and filling the material with alumina powder.

The adhesive was prepared from the following two-part system, with the mixture containing two measures of part “A” and 1 measure of part “B”:

| | |
|---|---|
| Ingredient | Concentration (weight %) |

Part A

| | |
|---|---|
| Sartomer CN992 Difunctional | 11 |
| Polyurethane Acrylate | |
| Blue Pigment | 0.1 |
| Triphenyl Phosphine | 0.01 |
| Alumina Powder | 88.89 |

Part B

| | |
|---|---|
| Trimethylolpropane Tris | 11 |
| (3-Mercaptopropionate) | |
| Diethoxyacetophenone | 0.2 |
| Alumina Powder | 88.8 |

The two-part adhesive material cured in less than 48 hours at 25° C. and within 60 seconds when exposed to H-lamp UV light with a power output of 1800W. The fully cured adhesive exhibited an adhesive strength of 200 psi as tested under ASTM D1002 with a lap shear test, a thermal conductivity of 2.0 W/m·K, and a modulus of elasticity at 25° C. of 20,000 psi as tested under ASTM D4065 with dynamic mechanical analysis.

### Example 2

A thermally conductive adhesive was prepared by mixing a difunctional alpha, beta unsaturated carbonyl containing compound with a trifunctional polyether thiol in the presence of a greater concentration of basic accelerator than in Example 1 and a photoinitiator and filling the material with alumina powder. The adhesive was prepared from the following two-part system, with the mixture containing two measures of part “A” and 1 measure of part “B”:

| | |
|---|---|
| Ingredient | Concentration (weight %) |

Part A

| | |
|---|---|
| Sartomer CN992 Difunctional | 10.8 |
| Polyurethane Acrylate | |
| Blue Pigment | 0.1 |
| Triphenyl Phosphine | 0.2 |
| Alumina Powder | 88.9 |

Part B

| | |
|---|---|
| Trimethylolpropane Tris | 11 |
| (3-Mercaptopropionate) | |
| Diethoxyacetophenone | 0.2 |
| Alumina Powder | 88.8 |

The two-part adhesive material fully cured in less than 1 hour at 25° C. and within 60 seconds when exposed to H-lamp UV light with a power output of 1800W. The fully cured adhesive exhibited an adhesive strength of 200 psi as tested under ASTM D1002 with a lap shear test, a thermal conductivity of 2.0 W/m·K, and a modulus of elasticity at 25° C. of 20,000 psi as tested under ASTM D4065 with dynamic mechanical analysis.

### Example 3

A thermally conductive adhesive was prepared by mixing a multifunctional unsaturated carbonyl containing compound with a trifunctional polyether thiol in the presence of a basic catalyst, a photoinitiator, and an adhesion promoter and filling the material with alumina powder. The adhesive was prepared from the following two-part system, with the mixture containing two measures of part “A” and 1 measure of part “B”:

| | |
|---|---|
| Ingredient | Concentration (weight %) |

Part A

| | |
|---|---|
| Sartomer CD9021, Highly | 10.5 |
| Propoxylated (5.5) Gylceryl | |
| Triacrylaye | |
| Blue Pigment | 0.1 |
| Triphenyl Phosphine | 0.01 |
| Mathacryloxypropyl Trimethoxy Silane | 0.6 |
| Alumina Powder | 88.79 |

Part B

| | |
|---|---|
| Trimethylolpropane Tris | 11 |
| (3-Mercaptopropionate) | |
| Diethoxyacetophenone | 0.2 |
| Alumina Powder | 88.8 |

The two-part adhesive material fully cured in 48 hours at 25° C. and within 60 seconds when exposed to H-lamp UV light with a power output of 1800W. The fully cured adhesive exhibited an adhesive strength of 500 psi as tested under ASTM D1002 with a lap shear test, a thermal conductivity of 2.0 W/m·K, and a modulus of elasticity at 25° C. of 100,000 psi as tested under ASTM D4065 with dynamic mechanical analysis.

The invention has been described herein in considerable detail in order to comply with the patent statutes, and to provide those skilled in the art with the information needed to apply the novel principles and to construct and use embodiments of the invention as required. However, it is to be understood that various modifications can be accomplished without departing from the scope of the invention itself.

What is claimed is:

1. A thermally conductive polymer adhesive polymerizable through a single reaction sequence that is driven by any one of a plurality of reaction initiators, wherein said reaction initiators include: (i) ultraviolet radiation;
and (ii) a temperature of 25° C. or less, said polymer adhesive having a thermal conductivity of at least 0.5 W/m·K.

2. A thermally conductive polymer adhesive as in claim 1, including a polymerized thiol and an alpha, beta unsaturated carbonyl.

3. A thermally conductive polymer adhesive that is fully curable at room temperature, and that is fully curable through exposure to ultra-violet radiation, said adhesive having a thermal conductivity of at least 0.5 W/m*K.

4. A thermally conductive adhesive as in claim 3 comprising a two-part liquid adhesive having an A-side and a B-side, said A-side including an unsaturated carbonyl material, and said B-side including a thiol-containing material.

5. A thermally conductive adhesive as in claim 4, including a photoinitiator in said A-side and/or B side.

6. A thermally conductive adhesive as in claim 4, including a basic accelerator in said A-side and/or B side.

7. A thermally conductive adhesive as in claim 4, including thermally conductive particulate filler.

8. A method for preparing a thermally conductive polymer adhesive, said method comprising:
(a) providing a two-part liquid reactant system, wherein a first part of said reactant system includes an unsaturated carbonyl-containing material, and a second part of said reactant system includes a thiol-containing material, at least one of said first and second parts including thermally conductive particulate filler;
(b) combining said first and second parts of said liquid reactant system to form a reaction mixture; and
(c) executing a polymerization reaction of said reaction mixture by exposing said reaction mixture to any one of a plurality of reaction initiators, wherein said reaction initiators include:
(i) ultraviolet radiation; and
(ii) a temperature of 25° C. or less.

9. A method as in claim 8, including sequentially exposing said reaction mixture first to ultraviolet radiation of between 200-500 nanometers for less than one minute, followed by exposing said reaction mixture to a temperature of 25° C. or less for up to about 48 hours.

10. A method for securing a first body to a second body, said method comprising:
(a) providing a thermally conductive liquid adhesive having a thermal conductivity of at least 0.5 W/m*K;
(b) applying said adhesive to said first body;
(c) mounting said second body to said adhesive exposed at said first body;
(d) exposing said adhesive to ultra-violet radiation for less than about 2 minutes; and
(e) after step (d), curing said adhesive at between about 15-25° C.

11. A method as in claim 10, including curing said adhesive at between about 15-25° C. for up to about 48 hours.

12. A method as in claim 10 wherein said adhesive, when fully cured, exhibits an adhesive strength of 75-750 psi.
